(19) United States
(12) Patent Application Publication
(10) Pub. No.: US 2007/0292818 A1
(43) Pub. Date: Dec. 20, 2007

(54) Dental casting tray assemblies

(76) Inventors: Michael Sullivan, Laguna Hills, CA (US); Ashwin Mehta, Cerritos, CA (US)

Correspondence Address: SNELL & WILMER LLP (OC), 600 ANTON BOULEVARD, SUITE 1400, COSTA MESA, CA, 92626, US

(21) Appl. No.: 11/471,230

(22) Filed: Jun. 20, 2006

(51) Int. Cl. A61C 19/00

(52) U.S. Cl. 433/34

(57) ABSTRACT

A casting tray and a base provide a dental model mounting device. The casting tray supports the dental model with a plurality of protrusions that extend into the dental model casting material. The casting tray snaps in and out of the base. The base has a socket for mounting on a dental articulator. The casting tray can be removed from the base, segmented, and reintegrated and realigned by snapping the segmented pieces back in the base.

### BACKGROUND OF THE INVENTION

1. Field of the Invention

The invention generally relates to devices used for forming dental models. More particularly, the invention relates to dental casting tray assemblies used for forming dental models.

2. Description of the Related Art

Dental models are often used to manufacture crowns, bridges, inlays, dentures and other dental prosthetics for the mouth of a patient. Manufacturing such dental prosthetics generally requires the ability to remove one or more individual model teeth from the dental model for the purpose of constructing accurate margins and contours. To accommodate this, dental models are often cut or otherwise separated into a number of working model segments, each segment including one or more individual model teeth. In many instances, it may be necessary that the working model segments be removed, analyzed, and accurately returned to their original positions precisely as they existed prior to any cutting, separations or disassembly of the dental model.

A dental model of the entire mouth of a patient typically includes an upper jaw model and a lower jaw model which are affixed to one another by an articulator. The articulator enables centric, lateral and protrusive movement of the upper jaw model relative to the lower jaw model in order to closely simulate the relationships and the actual movement, or bite, of the mouth of the patient.

One method of manufacturing dental models may include molding the dental model using a casting material. Typically, one or more impression trays are filled with an impression material and are then placed into the mouth of the patient so as to create a negative impression of the teeth of the patient in the impression material. After the negative impression has been formed, the impression tray is typically transported to a dental laboratory where the dental cast model is manufactured by filling the negative impression in the impression tray with a casting material, such as dental stone, plaster or epoxy. The impression tray is then inverted and mounted on a pre-formed mounting device, such as a dental casting tray that has been filled with the casting material. After the casting material has hardened, the impression tray may be removed so that the casting material forms a positive dental impression on the pre-formed mounting device.

To form the working model segments, the combination of the positive dental impression and the mounting device may be positioned on a cutting surface and a saw or other cutting device may be used to separate the desired model teeth from the remainder of the dental model. After the working model segments are formed, the desired model teeth can be removed from and then re-inserted into the dental casting tray. During reinsertion of each working model segment, it is important that each working model segment be positioned in the proper location and orientation within the dental casting tray.

### SUMMARY OF THE INVENTION

The invention provides a device that performs this precise registration and alignment function. The dental model mounting device comprises a dental casting tray and a base. The casting tray provides a mounting surface for mounting a dental model. The casting tray mates with the base that in turn couples to one of the arms of a dental articulator. In one embodiment, a dental casting tray assembly comprises a casting tray comprising inner walls, a bottom portion and outer walls, the outer walls having saw-toothed contours and a base comprising inner walls having saw-toothed contours that mate with the saw-toothed contours of the outer walls of the casting tray.

The casting tray holds dental casting material such as gypsum. The casting tray features a plurality of protrusions that extend inward increasing the surface area in contact with the casting material. The casting tray also features saw-toothed walls that mate with complementary saw-toothed walls of the base. A locking structure that extends throughout most of the length the casting tray and the base allows the casting tray and base to be snapped together to form a single rigid structure. The base features a socket that couples to the mandible or maxilla portion of an articulator.

Slightly concave saw-toothed walls that taper from top to bottom in both the casting tray and base insure precise alignment of the casting tray relative to the base. The locking structure allows the base and the casting tray to be snapped together. The structures extend through most of the base and the casting tray allowing the casting tray to be separated from the base, sectioned into working models, and precisely reassembled in the base. Numbering along the length of the casting tray facilitates the reassembly process.

A dental model is formed by placing the casting tray inside the base and snapping together. An alignment notch in the casting tray and a matching cutout in the base insure correct orientation of the base relative to the casting tray. A dental impression of a patient obtained using a dental tray is then sprayed with a germicide. A technician prepares a casting material and fills the impression and the casting tray with the casting material. The impression tray is then inverted on the casting tray and set to cure. After the casting material hardens, the technician can remove the dental tray and a mounted dental model remains.

The casting tray can then be removed from the base. The technician sections the dental model into working model segments by placing the casting tray and dental model on a flat surface and the dental model and casting tray is cut using a sharp knife or saw. After working with the model segments, the technician returns the model segments to the base. The technician simply places the segments in the tray in numerical order using the inscribed numerals on the casting tray segments. Each of the model segments snaps into the base. The structure of casting tray segments and the base insures precise registration and alignment the model segments.

After reassembly of the dental model, the technician attaches the casting tray assembly to the maxilla or mandible arm of an articulator. The articulator can then be used to test or make further measurements for a crown, bridge or other dental device. The model segments can be removed and replaced multiple times allowing the technician to re-measure, redesign, and retest refining the dental structure to insure accurate margins and contours.

### BRIEF DESCRIPTION OF THE DRAWINGS

The exact nature of this invention as well as its objects and advantages will be readily understood upon consideration of the following specification as related to the attendant drawings wherein like reference numerals throughout the drawings indicate like parts, and wherein:

FIG. 1 illustrates a perspective view of a casting tray assembly including a base and a casting tray.

FIG. 2A illustrates a top view of the casting tray;

FIG. 2B illustrates an exploded top view of a portion of FIG. 2A;

FIG. 3 illustrates a bottom view of the casting tray of FIG. 1;

FIG. 4 illustrates a front view of the casting tray of FIG. 1;

FIG. 5 illustrates a side view of the casting tray of FIG. 1;

FIG. 6 illustrates a top view of the base of FIG. 1;

FIG. 7 illustrates a bottom view of the base of FIG. 1;

FIG. 8 illustrates a side view of the base of FIG. 1;

FIG. 9 illustrates a top view of a casting tray;

FIG. 10 illustrates a side view of the casting tray of FIG. 9;

FIG. 11 illustrates a top view of a base;

FIG. 12 illustrates a side view of the base of FIG. 11;

FIG. 13 illustrates a perspective view of a mounting device that is used to hold the casting tray in place so that it may be cut into a number of sections; and

FIG. 14 is an exploded end view of the mounting device of FIG. 13 illustrating the groove.

### DESCRIPTION OF THE PREFERRED EMBODIMENTS

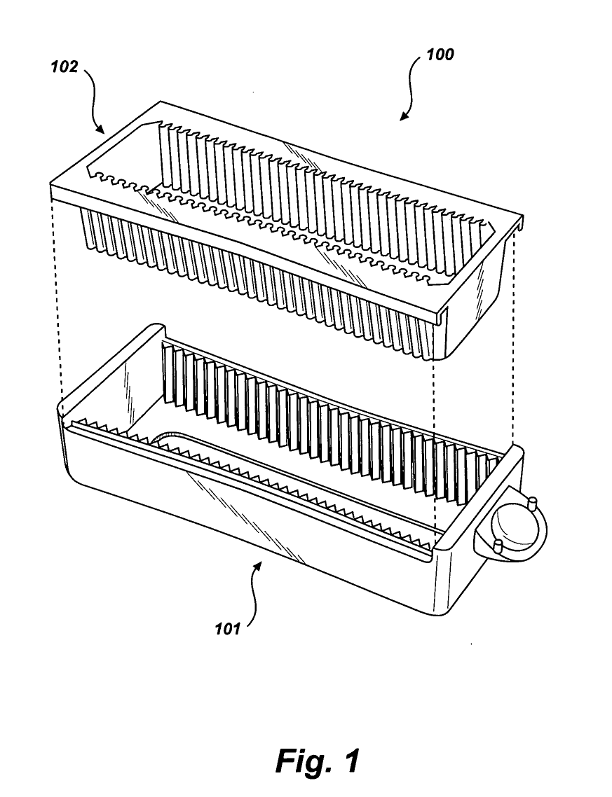

FIG. 1 illustrates a perspective view of a casting tray assembly 100 including a base 101 and a casting tray 102. The casting tray 102 fits into the base 101. As shown in FIG. 1, the casting tray assembly 100 may be formed in the shape of a rectangle.

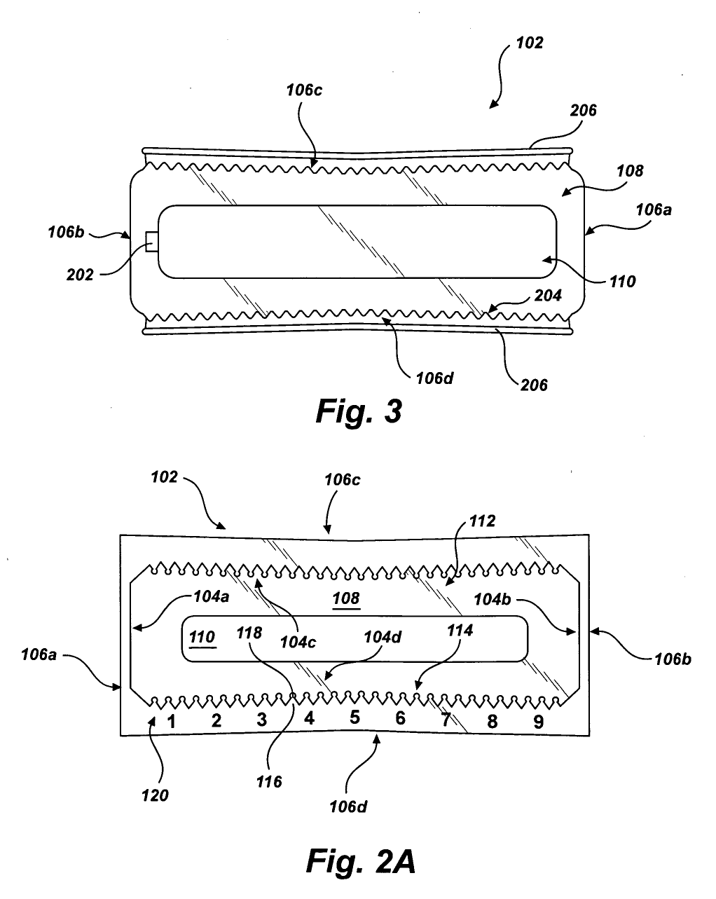

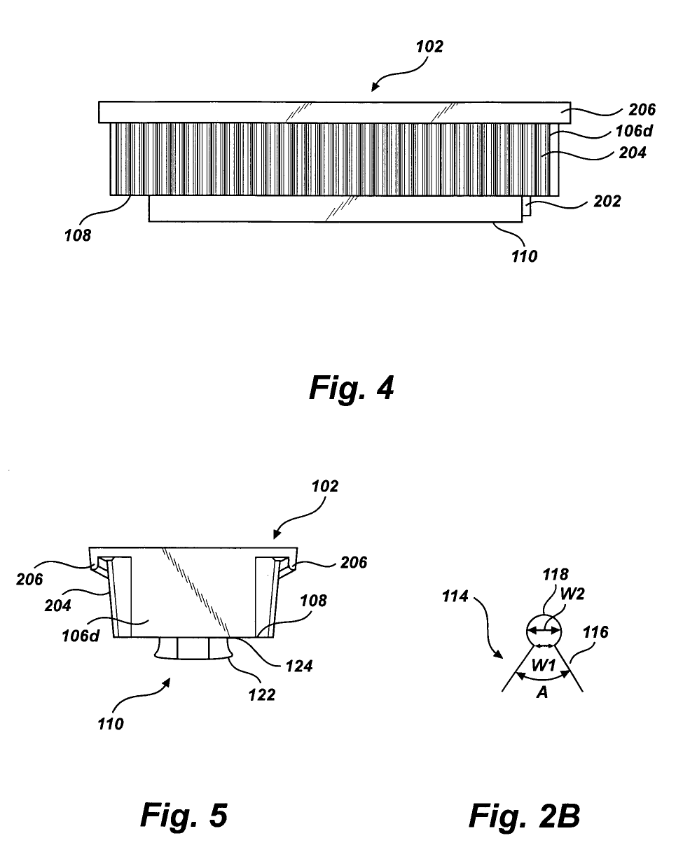

FIG. 2A illustrates a top view of the casting tray 102 and FIG. 2B illustrates an exploded top view of a portion of FIG. 2A. The casting tray 102 may have inner walls 104a-d, outer walls 106a-d, a bottom portion 108 and a locking portion 110. The casting tray 102 may include a cavity 112 defined by the inner walls 104a-d, the bottom portion 108 and/or the locking portion 110. The locking portion 110 may extend below the bottom portion 110. The cavity 112 may be filled with gypsum material or other casting material. The casting tray 102 may have a length L of about 6.5 centimeters (cm), a width W of about 2.9 cm and a height H of about 1.5 cm. In one embodiment, the casting tray 102 is made of a high impact styrene. The casting tray 102 may be made of any solid material (e.g., plastic) that retains liquid, semi liquid or solid dental casting material and does not deform or crack when cut.

The inner walls 104a and 104b are substantially parallel to one another. The inner walls 104c and 104d are slightly concave (i.e., curved inward) along the length of the casting tray 102. In one embodiment, the inner walls 104a and 104b and the outer walls 106a and 106b are slightly concave. In other embodiments, the inner walls 104a and 104b and the outer walls 106a and 106b may have shapes such as concave or convex or monotonically increasing or decreasing. The shape of the casting tray 102 assures that the dental model segments are reassembled in the base 101 precisely and that the segmented sections fit in the appropriate positions.

The inner walls 104c and 104d may have protrusions 114 that extend the entire wall height and length. The protrusions 114 may have a first portion 116 and a second portion 118. When viewed from the top, the first portion 116 may be formed in the shape of a triangle and the second portion 118 may be formed in the shape of a circle or oval. The triangular shape and the oval shape may extend the entire wall height. The first and second portions 116 and 118 may have other shapes. The first portion 116 generally terminates where the second portion 118 begins. In one embodiment, a width W2 of a widest point of the second portion 118 is generally larger than a width W1 of a narrowest point of the first portion 116. An angle A of the first portion 116 may be between about 5 and 90 degrees. Preferably, the angle A may be between about 40 and 60 degrees.

The protrusions 114 are used to retain the gypsum cast after solidification. The protrusions 114 provide the inner walls 104c and 104d a large surface area to attach to the gypsum material. The large surface area allows a better and stronger bond between the casting tray 102 and the solidified gypsum material. Also, the large surface area allows a technician to cut the casting tray 102 into multiple sections without the solidified gypsum separating from the segmented casting tray 102. Once the casting tray 102 is cut into multiple sections, each section may be removed from the base 101. The slightly concave inner walls 104c and 104d prevent each section from being inserted into an incorrect location because each section has a slightly different shape. The casting tray 102 may have numbers 120 that appears along its length below the protrusions 114 of the inner walls 104c and 104d. The numbers 120 may be used as a guide to cut the casting tray 102 into multiple sections. Also, the numbers 120 may provide indicia for easy reassembly of each section of the casting tray 102 in the base 101.

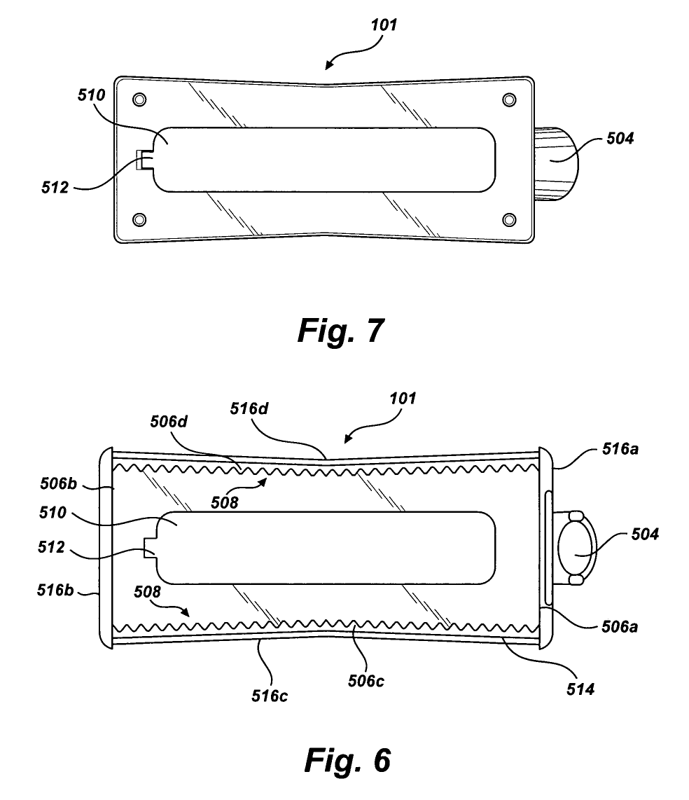

FIG. 3 illustrates a bottom view of the casting tray 102 of FIG. 1. The bottom portion 108 may surrounds the locking portion 110. In one embodiment, the bottom portion 108 extends across the entire bottom surface of the cavity 112 without the locking portion 110 creating an indentation in the bottom portion 108. Rather, the locking portion 110 extends downward from the bottom portion 108 as shown in FIG. 5. An alignment notch 202 may be located adjacent to the locking portion 110. The alignment notch 202 of the casting tray 102 may mate with an alignment cutout 512 of the base 101 to ensure that the casting tray 102 fits into the base 101 in the proper orientation (see also FIGS. 6 and 7). The outer walls 106c and 106d may have saw-toothed contours 204 that mate with similar saw-toothed contours 508 of the inner walls 506c and 506d of the base 101. Preferably, the saw-toothed contours 204 form angles of between about 5 and 90 degrees, thus allowing more precise alignment of the casting tray 102 with the base 101. The casting tray 102 may include a lip 206 for providing a secure fit between the casting tray 102 and the base 101. For example, the lip 206 allows each section of the casting tray 102 to have a more secure fit to the base 101. Also, the lip 206 prevents gypsum or other casting material from entering an area between the casting tray 102 and the base 101.

FIG. 4 illustrates a front view of the casting tray 102 of FIG. 1. The lip 206 may extend the entire length of the casting tray 102. The outer wall 106d has the saw-toothed contours 204 that extend from the top to the bottom of the casting tray 102. The locking portion 110 and the alignment notch 202 extend below the bottom portion 108 to provide locking and alignment with the base 101.

FIG. 5 illustrates a side view of the casting tray 102 of FIG. 1. The lip 206 extends down from both sides of the casting tray 102. The outer wall 106a has a smooth flat surface. The locking portion 110 extends down from the bottom portion 108 and fits into an opening of the base 101. In one embodiment, a lower section 122 of the locking portion 110 has a larger perimeter than an upper section 124 of the locking portion 110. The difference in perimeter allows the casting tray 102 to lock or snap into an opening 510 of the base 101.

FIG. 6 illustrates a top view of the base 101 of FIG. 1. The base 101 provides a receptacle for the casting tray 102. The base 101 may have a socket 504 that couples to the mandible or maxilla positions of an articulator (not shown). The base 101 has complementary features that allow the casting tray 102 to fit snugly into the base 101. For example, the inner walls 506a-d of the base 101 have saw-toothed contours 508, similar to the saw-toothed contours 204 of the casting tray 102, that extend from the top to the bottom of the base 101. The base 101 has inner walls 506a-d that are sized and shaped to mate with the outer walls 106a-d of the casting tray 102. Preferably, the saw-toothed contours 508 form angles of between about 5 and 90 degrees, thus allowing more precise alignment of the casting tray 102 with the base 101. The base 101 has an opening 510 that is sized and shaped to receive the locking portion 110 of the casting tray 102. The alignment cutout 512 is sized and shaped to receive the alignment notch 202. Also, the base 101 has a cutout 514 that receives the lip 206 of the casting tray 102. When the casting tray 102 is in the base 101, the lip 206 fits into the cutout 514 and is flush with outer walls 516c and 516d.

FIG. 7 illustrates a bottom view of the base 101 of FIG. 1. The opening 510 and the locking portion 110 (FIG. 6) form a latching structure. The casting tray 102 fits snuggly in the base 101. The casting tray 102 snaps into the base 101 by placing the casting tray 102 inside the base 101 and applying slight pressure to the casting tray 102. The lower section 122 of the locking portion 110 penetrates a plane defined by the opening 510 and locks the casting tray 102 to the base 101. The larger perimeter of the lower section 122 when compared with the upper section 124 allows the locking portion 110 to snap into the opening 510. The alignment notch 202 and alignment cutout 512 prevent the casting tray 102 and the base 101 from snapping together in the incorrect orientation.

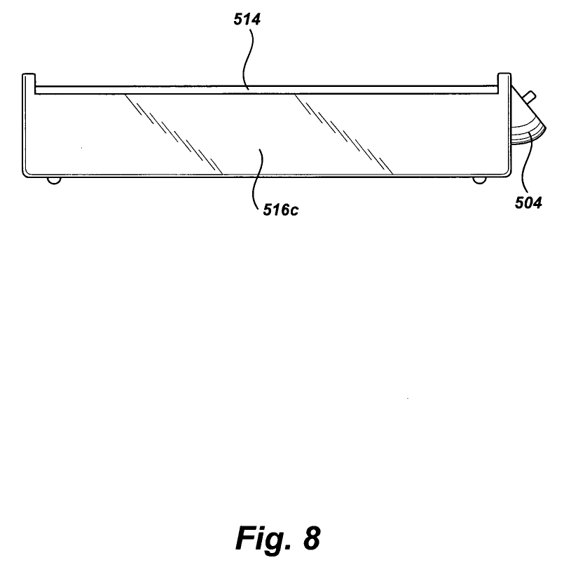

FIG. 8 illustrates a side view of the base 101 of FIG. 1.

The base 101 and the casting tray 102 form a mounting assembly for a dental model. To create the dental model, an impression tray composed largely of elastic material may be urged into the patient's mouth leaving a dental impression of the patient's teeth. A technician may spray the impression tray with germicide and form a mix of gypsum material. The gypsum material may be poured into the impression tray to completely fill the impression tray. The technician may also fill the casting tray 102, when inside the base 101, with the gypsum material. The impression tray may then be inverted and placed over the casting tray 102 so that the gypsum material in the impression tray is in contact with the gypsum material in the casting tray 102. In one embodiment, the impression tray is aligned so that the rear most teeth are closest to the socket 504. The technician may allow the gypsum material to cure or harden and then may remove the impression tray producing a dental model mounted on the casting tray 102.

The casting tray 102 may be segmented into multiple sections using a knife or saw to facilitate the design of an appropriate bridge crown or other dental structure. The protrusions 114 provide greater surface area for the gypsum material to attach to the segmented sections of the casting tray 102. Each segmented section may be removed from and reinserted into the casting tray 102 to reform the dental model. The locking portion 110 and the opening 510 allow each segmented section of the casting tray 102 to snap into the base 101. The outer walls 106c and 106d and the inner walls 506c and 506d have complimentary concave contours and saw-toothed contours that assure the precise alignment and registration of each section of the dental model.

Once the segmented sections of the casting tray 102 are placed or snapped back in the base 101, the socket 504 can be placed on the mandible or maxilla arms of an articulator. The articulator may be used to test dentures, crowns, bridges, inlays, onlays or orthodontic appliances.

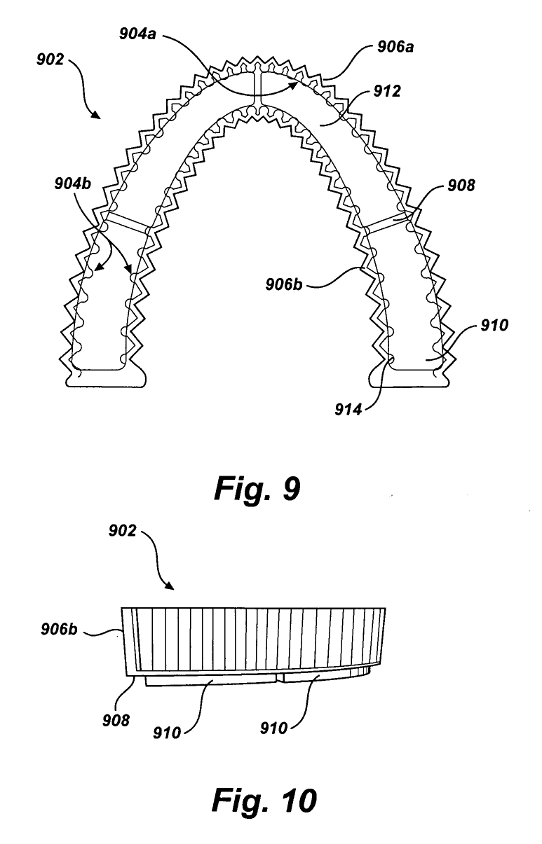

FIG. 9 illustrates a top view of a casting tray 902. The casting tray 902 may be formed as a U-shaped casting tray to create a full mouth dental model. The casting tray 902 may have inner walls 904a and 904b, outer walls 906a and 906b, a bottom portion 908 and a locking portion 910. The casting tray 902 may include a cavity 912 defined by the inner walls 904a and 904b, the bottom portion 908 and/or the locking portion 910. The cavity 912 may be filled with gypsum material or other casting material. In one embodiment, the inner walls 902a and 902b converge inward from the back end (i.e., back teeth) to the front end (i.e., front teeth). Hence, the cavity 912 has different widths at different locations. In one embodiment, the inner walls 904a and 904b and the outer walls 906a and 906b may be arcuate shaped. In other embodiments, the inner walls 904a and 904b and the outer walls 906a and 906b may have shapes such as concave or convex or monotonically increasing or decreasing. The shape of the casting tray 902 assures that the dental model segments are reassembled in a base 1002 precisely and that the segmented sections fit in the appropriate positions.

The inner walls 904a and 904b may have protrusions 914 that extend the entire wall height. The protrusions 914 may be similar to the protrusions 114 of FIGS. 2A and 2B. The protrusions 914 may have a first portion 916 and a second portion 918. When viewing from the top, the first portion 916 may be formed in the shape of a triangle and the second portion 918 may be formed in the shape of a circle or oval. The triangular shape and the oval shape may extend the entire wall height. The first and second portions 916 and 918 may have other shapes. The first portion 916 generally terminates where the second portion 918 begins. The protrusions 914 provide the inner walls 904a and 904b a large surface area to attach to the gypsum material. The large surface area allows a better and stronger bond between the casting tray 902 and the solidified gypsum material. Also, the large surface area allows a technician to cut the casting tray 902 into multiple sections without the solidified gypsum material separating from the segmented casting tray 902. Once the casting tray 902 is cut into multiple sections, each section may be removed from the base 1002. The slightly curved inner walls 904a and 904b prevent each section from being inserted into an incorrect location because each section has a slightly different shape.

FIG. 10 illustrates a side view of the casting tray 902 of FIG. 9. The outer walls 906a and 906b have saw-toothed contours that extend from the top to the bottom of the casting tray 902. The locking portion 910 extends down from the bottom portion 908 to provide a locking and alignment structure.

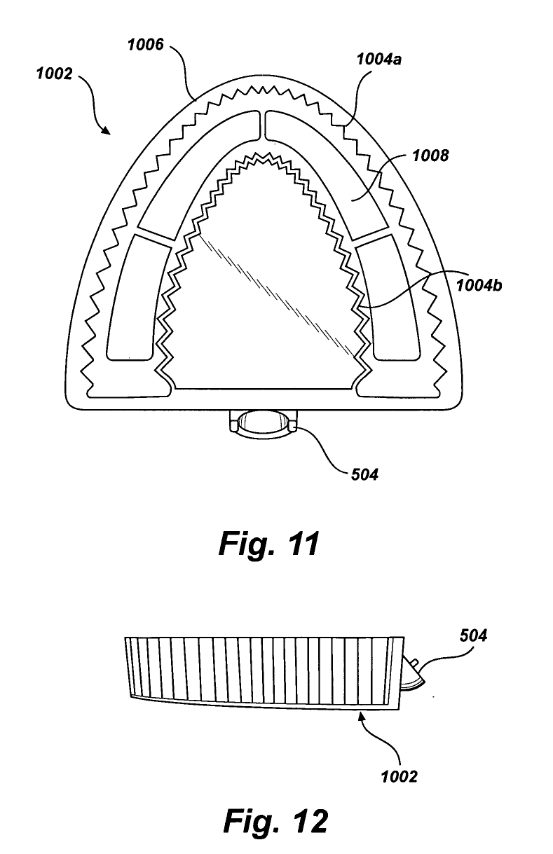

FIG. 11 illustrates a top view of the base 1002 of FIG. 10. The base 1002 provides a receptacle for the casting tray 902. The base 1002 has a socket 504 that couples to the mandible or maxilla positions of an articulator (not shown). The base 1002 has complementary features that allow the casting tray 1002 to mate with the base 902. Complementary inner walls 1004a and 1004b of the base 1002 have dimensions slightly greater than the outer walls 906a and 906b of the casting tray 902. Complementary inner walls 1004a and 1004b features complementary saw-toothed contours that taper from top to the bottom of the base 1002. The base 1002 has an outer wall 1006 and a bottom surface 1008.

FIG. 12 illustrates a side view of the base 1002 of FIG. 11. The casting tray 902 has the socket 504 that couples to the mandible or maxilla positions of an articulator (not shown).

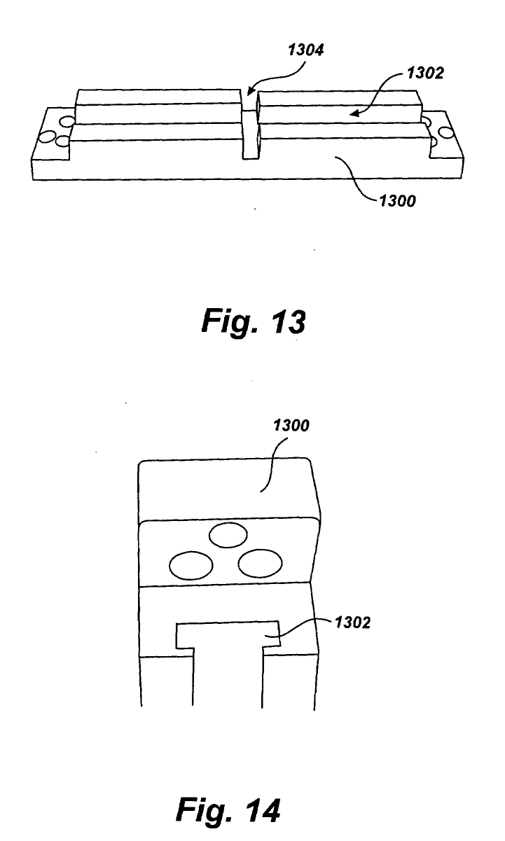

FIG. 13 illustrates a mounting device 1300 that is used to hold the casting tray 102 in place so that it may be cut into a number of sections. The casting tray 102 may slide into a groove 1302. In one embodiment, the locking portion 110 of the casting tray 102 may fit into the groove 1302 of the mounting device 1300 and can slide toward a cutout 1304. A user generally moves the casting tray 102 in the groove 1302 so that the portion of the casting tray 102 that is to be cut is aligned up with the cutout 1304. The user may use a manual saw or a power circular saw to cut the casting tray 102 along the cutout 1304. The mounting device 1300 may be made from a steel, aluminum or plastic material.

FIG. 14 is an exploded end view of the mounting device 1300 of FIG. 13 illustrating the groove 1302. The casting tray 102 can slide left and right along the groove 1302 but cannot move forwards and backwards. When cutting the casting tray 102, the mounting device 1300 prevents the casting tray 102 from forwards and backwards, which is the direction the saw travels in.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope.

What is claimed is:

1. A dental casting tray assembly comprising:
a casting tray comprising inner walls, a bottom portion and outer walls, the outer walls having saw-toothed contours; and
a base comprising inner walls having saw-toothed contours that mate with the saw-toothed contours of the outer walls of the casting tray.

2. The dental casting tray assembly of claim 1 wherein the inner walls of the casting tray are concave.

3. The dental casting tray assembly of claim 1 wherein the inner walls of the base are concave.

4. The dental casting tray assembly of claim 1 wherein the casting tray further comprises a locking portion that extends from the bottom portion.

5. The dental casting tray assembly of claim 4 wherein the base has an opening that receives the locking portion to secure the casting tray to the base.

6. The dental casting tray assembly of claim 4 wherein the locking portion has lower and upper sections, the lower section having a larger perimeter than the upper section.

7. The dental casting tray assembly of claim 1 wherein at least one of the inner walls of the casting tray has a plurality of protrusions.

8. The dental casting tray assembly of claim 6 wherein the plurality of protrusions have a first portion formed in the shape of a triangle and a second portion formed in the shape of a circle.

9. The dental casting tray assembly of claim 1 wherein the casting tray has an alignment notch that is connected to the bottom portion of the casting tray and the base has an alignment cutout shaped to receive the alignment notch.

10. A dental casting tray assembly comprising:
a casting tray comprising inner walls, a bottom portion and outer walls, the inner walls of the casting tray are concave; and
a base comprising inner walls that are concave.

11. The dental casting tray assembly of claim 10 wherein the outer walls of the casting tray have saw-toothed contours.

12. The dental casting tray assembly of claim 11 wherein the inner walls of the base have saw-toothed contours that mate with the saw-toothed contours of the outer walls of the casting tray.

13. The dental casting tray assembly of claim 10 wherein the casting tray further comprises a locking portion that extends from the bottom portion.

14. The dental casting tray assembly of claim 13 wherein the base has an opening that receives the locking portion to secure the casting tray to the base.

15. The dental casting tray assembly of claim 13 wherein the locking portion has lower and upper sections, the lower section having a larger perimeter than the upper section.

16. The dental casting tray assembly of claim 10 wherein at least one of the inner walls of the casting tray has a plurality of protrusions.

17. The dental casting tray assembly of claim 16 wherein the plurality of protrusions have a first portion formed in the shape of a triangle and a second portion formed in the shape of a circle.

18. The dental casting tray assembly of claim 10 wherein the casting tray has an alignment notch that is connected to the bottom portion of the casting tray and the base has an alignment cutout shaped to receive the alignment notch.

19. A dental apparatus comprising:
a tray defining a cavity and having a plurality of vertical protrusions extending into the cavity, each of the plurality of vertical protrusions having a base portion and an end portion that is wider than the base portion; and
a base sized and shaped to receive the tray.

20. The dental apparatus of claim 19 wherein the tray comprises inner walls, a bottom portion and outer walls, the outer walls having saw-toothed contours and the base comprises inner walls having saw-toothed contours that mate with the saw-toothed contours of the outer walls of the tray.

21. The dental apparatus of claim 20 wherein the inner walls of the casting tray are concave.

22. The dental apparatus of claim 20 wherein the inner walls of the base are concave.

23. The dental apparatus of claim 20 wherein the tray further comprises a locking portion that extends from the bottom portion.

24. The dental apparatus of claim 20 wherein the base has an opening that receives the locking portion to secure the tray to the base.

25. The dental apparatus of claim 19 wherein the cavity varies in width along its length.
